(19) United States
(12) Patent Application Publication
(10) Pub. No.: US 2013/0237216 A1
(43) Pub. Date: Sep. 12, 2013

(54) SCANNING RESPONSES IN WIRELESS NETWORK

(71) Applicants: Eng Hwee ONG, Espoo (FI); Jarkko Kneckt, Espoo (FI); Mika Kasslin, Espoo (FI); Gabor Bajko, Sunnyvale, CA (US)

(72) Inventors: Eng Hwee ONG, Espoo (FI); Jarkko Kneckt, Espoo (FI); Mika Kasslin, Espoo (FI); Gabor Bajko, Sunnyvale, CA (US)

(73) Assignee: Nokia Corporation, Espoo (FI)

(21) Appl. No.: 13/415,040

(22) Filed: Mar. 8, 2012

(51) Int. Cl. H04W 4/00

(52) U.S. Cl. 455/434

(57) ABSTRACT

This document discloses a solution for transmitting scanning response messages in an orderly manner in a wireless network. An access node determines a transmission order for a plurality of access nodes responding to a scanning request message provided by a scanning/requesting device. Then, the access node determines its own transmission turn within the transmission order and transmits a scanning response message with reduced channel contention. Another aspect relates to the scanning device arranged to receive the scanning response messages where the scanning device monitors the transmission order of the scanning response messages.

### FIELD

The invention relates to the field of wireless networks and, particularly, to processing scanning request messages and scanning response messages in a wireless network.

### BACKGROUND

Some modern wireless networks employ an active scanning procedure in which a scanning device scans for presence of wireless networks. The active scanning comprises transmitting a scanning request message and any access node of a wireless network detecting the scanning request may respond to it by transmitting a scanning response message. However, in a case where there are several wireless networks present in the area, the number of scanning responses may become substantially high which causes high signalling overhead and increases channel collisions.

### BRIEF DESCRIPTION

According to an aspect of the present invention, there is provided a method comprising: acquiring, in an access node of a wireless network, neighbour access node information comprising at least one of identification, geographical location, and characteristics of at least one neighbouring access node; acquiring a scanning request message originated from a requesting device; determining, at least partly on the basis of the neighbour access node information, a transmission order of a plurality of scanning responses that respond to the scanning request; and causing the access node to transmit a scanning response during a transmission turn of the access node determined from the transmission order.

According to another aspect of the present invention, there is provided a method comprising: causing a scanning device to transmit a scanning request comprising context information to a plurality of access nodes; acquiring in the scanning device a scanning response from an access node, wherein the scanning response comprises an information element indicating a transmission turn of the scanning response in a transmission order of a plurality of scanning responses responding to the scanning request.

According to another aspect of the present invention, there is provided an apparatus comprising at least one processor and at least one memory comprising a computer program code. The at least one memory and the computer program code are configured, with the at least one processor, to cause the apparatus to: acquire neighbour access node information comprising at least one of identification, geographical location, and characteristics of at least one neighbouring access node; acquire a scanning request message originated from a requesting device; determine, at least partly on the basis of the neighbour access node information, a transmission order of a plurality of scanning responses that respond to the scanning request; and cause an access node to transmit a scanning response during a transmission turn of the access node determined from the transmission order.

According to another aspect of the present invention, there is provided an apparatus comprising at least one processor and at least one memory comprising a computer program code. The at least one memory and the computer program code are configured, with the at least one processor, to cause the apparatus to: cause a scanning device to transmit a scanning request comprising context information to a plurality of access nodes; acquire a scanning response from an access node, wherein the scanning response comprises an information element indicating a transmission turn of the scanning response in a transmission order of a plurality of scanning responses responding to the scanning request.

According to another aspect of the present invention, there is provided an apparatus comprising: means for acquiring, in an access node of a wireless network, neighbour access node information comprising at least one of identification, geographical location, and characteristics of at least one neighbouring access node; means for acquiring a scanning request message originated from a requesting device; means for determining, at least partly on the basis of the neighbour access node information, a transmission order of a plurality of scanning responses that respond to the scanning request; and means for causing the access node to transmit a scanning response during a transmission turn of the access node determined from the transmission order.

According to another aspect of the present invention, there is provided an apparatus comprising means for causing a scanning device to transmit a scanning request comprising context information to a plurality of access nodes; and means for acquiring in the scanning device a scanning response from an access node, wherein the scanning response comprises an information element indicating a transmission turn of the scanning response in a transmission order of a plurality of scanning responses responding to the scanning request.

According to yet another aspect of the present invention, there is provided a computer program product embodied on a distribution medium readable by a computer and comprising program instructions which, when loaded into the computer, execute a computer process comprising: acquiring, in an access node of a wireless network, neighbour access node information comprising at least one of identification, geographical location, and characteristics of at least one neighbouring access node; acquiring a scanning request message originated from a requesting device; determining, at least partly on the basis of the neighbour access node information, a transmission order of a plurality of scanning responses that respond to the scanning request; and causing the access node to transmit a scanning response during a transmission turn of the access node determined from the transmission order.

According to yet another aspect of the present invention, there is provided a computer program product embodied on a distribution medium readable by a computer and comprising program instructions which, when loaded into the computer, execute a computer process comprising: causing a scanning device to transmit a scanning request comprising context information to a plurality of access nodes; acquiring in the scanning device a scanning response from an access node, wherein the scanning response comprises an information element indicating a transmission turn of the scanning response in a transmission order of a plurality of scanning responses responding to the scanning request.

Embodiments of the invention are defined in the dependent claims.

### LIST OF DRAWINGS

Embodiments of the present invention are described below, by way of example only, with reference to the accompanying drawings, in which

FIG. 1 illustrates a communication scenario to which embodiments of the invention may be applied;

FIG. 2 illustrates a signalling diagram of an embodiment for determining a transmission order for a plurality of scanning response messages according to an embodiment of the invention;

FIG. 3 is a flow diagram related to an embodiment where identifiers of access nodes are used when determining the transmission order according to an embodiment of the invention;

FIG. 4 is a flow diagram related to an embodiment where locations of the access nodes are used when determining the transmission order according to an embodiment of the invention;

FIG. 5 illustrates an embodiment where the number of responding access nodes is limited by using a geographical limitation according to an embodiment of the invention;

FIG. 6 is a flow diagram related to an embodiment where service characteristics of the access nodes are used when determining the transmission order according to an embodiment of the invention;

FIG. 7 is a flow diagram related to an embodiment where multiple criteria are used when determining the transmission order according to an embodiment of the invention;

FIG. 8 is a flow diagram related to an embodiment where the transmission order is updated according to an embodiment of the invention;

FIG. 9 is a flow diagram of a process carried out in a scanning device for detecting a number of missed scanning responses according to an embodiment of the invention; and

FIGS. 10 and 11 illustrate block diagrams of apparatuses according to some embodiments of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

A general architecture of a wireless communication system to which embodiments of the invention may be applied is illustrated in FIG. 1. FIG. 1 illustrates wireless communication devices forming wireless networks that may be referred to as service sets. A basic service set (BSS) may be defined by a group of wireless communication devices comprising an access point (AP) 102, 104, 106 and one or more terminal stations (STA) 110 communicating with one of the access points 102, 104, 106 depending on with which BSS the STA associates to for frame transmission. The BSS is a basic building block of an IEEE 802.11 wireless local area network (WLAN), and it may have a determined coverage area defined by the coverage area of the AP 102, 104, 106, for example. The most common BSS type is an infrastructure BSS that includes a single AP together with all associated, non-access-point STAs. The AP may be a fixed AP as APs 102, 104, 106, but it should be appreciated that in some embodiments at least one of the APs 102 to 106 may be a mobile AP. The APs 102, 104, 106 may also provide access to other networks, e.g. the Internet. In another embodiment, at least one of the BSSs is an independent BSS (IBSS) or a mesh BSS (MBSS) without a dedicated AP, e.g. the communication device 106 may in such an embodiment be a non-access-point terminal station. Yet another embodiment of the service set is an extended service set (ESS) which may be defined as a set of one or more interconnected BSSs that appear as a single BSS to the STAs. In the scenario illustrated in FIG. 1, the AP 106 serves as a single access point of a BSS, while APs 102, 104 form an ESS comprising a plurality of APs. The coverage areas of the respective service sets are shown by the dotted line in FIG. 1.

While embodiments of the invention are described below in the context of the above-described topologies of IEEE 802.11, it should be appreciated that other embodiments of the invention are applicable to networks based on other specifications, e.g. WiMAX (Worldwide Interoperability for Microwave Access), UMTS LTE (Long-term Evolution for Universal Mobile Telecommunication System), and other networks having cognitive radio features, e.g. transmission medium sensing features and capability to adopt operational parameters to enable coexistence with radio access networks based on different specifications and/or standards.

The service sets are represented by the APs and/or STAs connected to each other, thereby establishing a service set which may be a BSS, IBSS, MBSS, or ESS. The STA 110 may establish a connection to any one of the APs 102, 104, 106. The connection establishment may include authentication in which an identity of a STA is established in the AP. The authentication may comprise exchanging an encryption key used in the BSS. After the authentication, the AP and the STA may carry out association in which the STA is fully registered in the BSS, e.g. by providing the STA with an association identifier (AID) for frame transmissions.

The APs 102 to 106 may establish a signalling interface for exchanging any information relevant for the coexistence of the APs 102 to 106. This signalling interface is represented in FIG. 1 by a distribution system (DS) 120. The DS may be a wired backbone providing wired connections between the APs 102 to 106, and/or at least some of the links of the DS 120 may be wireless, e.g. in a case of mobile APs. An AP may provide the other APs with information on its communication parameters, information on other BSSs that the AP has discovered and their respective communication parameters, etc. In an embodiment, the DS 120 is provided only amongst the APs of the same ESS, while in other embodiments the DS 120 is provided also between the different service sets. In the former embodiment, at least some of the information exchanged over the DS 120 may be exchanged over the radio interface between the different service sets. In this context, the information may be included in channel access coordination information element to be transmitted as part of the management frames such as beacon frames, measurement pilot frames, and other scanning messages.

In some embodiments, at least some of the APs 102 to 106 are connected to a server controlling at least some of the operations of the APs. The server may provide centralized control of at least some of the communication parameters of the APs. The connections between the APs and the server may be realized through the DS 120. The server may be an ESS server controlling the operation of APs within the same ESS, for example. In another embodiment, the server controls the operation of APs belonging to different service sets or different wireless networks.

An 802.11n specification specifies a data transmission mode in which a STA can have only one secondary channel which results in a maximum bandwidth of 40 MHz. The primary channel is used in all transmissions, and with associated devices supporting only the 20 MHz mode. The secondary channel may be used with clients supporting wider transmission bandwidths, wherein the primary channel communication is extended by using the secondary channel as additional bandwidth. A further definition in the 802.11n is that the primary and secondary channels are adjacent. The IEEE 802.11ac task group is developing an extension with a data transmission model to provide for wider bandwidths by increasing the number of secondary channels from 1 up to 7, thus resulting in bandwidths of 20 MHz, 40 MHz, 80 MHz, and 160 MHz.

The primary channel may be used for connection establishment leading to association between two wireless apparatuses between which the connection is to be established. A wireless apparatus preparing for the association may scan for channels in order to detect a signal indicating presence of another wireless apparatus for association. The wireless apparatus may be in a completely unassociated state or it may have at least one existing association while seeking for a reassociation. IEEE 802.11 network discovery mechanisms define two modes: passive and active scanning. In the passive scanning, the wireless apparatus scans a channel for up to a maximum period of time. If a wireless network is discovered by detecting a scanning message transmitted by the wireless network, the wireless apparatus may proceed to connection establishment or, otherwise, it may tune to another channel. The scanning messages the wireless apparatus may scan for comprise beacon frames, measurement pilot frames, or any other frames. The measurement pilot frame may be defined as a short action frame comprising a subset of information contained in the beacon frame, but the measurement pilot frame may be transmitted more frequently than the beacon frames. The frames may be originated from any AP or destined to any AP or, alternatively, the wireless apparatus scans for frames that meet the given criteria e.g. a determined identifier, such that the wireless apparatus is able to detect any wireless network, including IBSSs and mesh BSSs. When the wireless apparatus uses the active scanning, it generates a probe request frame and transmits the probe request frame in order to request APs or, in general, other wireless apparatuses to reply with probe response frames. The probe response frames may thus also be considered to be scanning messages the wireless apparatus is attempting to detect. The rules applied to the requesting device (e.g. a STA) and the responding device (e.g. an AP) during the active scanning may be defined as follows. Upon tuning to a new channel, e.g. a new frequency channel, the requesting device may first scan the channel for a determined period of time, e.g. a probe delay, or until it detects a frame header, e.g. a physical layer convergence protocol (PLCP) header, on the channel. Thereafter, the requesting device may initiate a channel contention so as to gain a transmission opportunity for transmission of a probe request frame. The requesting device may transmit one or more probe request frames comprising information (for example, a service set identifier (SSID) field and/or a BSS identifier field) specifying which wireless apparatus may respond to the probe request. The requesting device may also reset a probe timer to zero and start it upon transmitting the probe request. If the requesting device detects no WLAN signal with sufficiently high energy on the channel on which the probe request was transmitted before the probe timer reaches a minimum probe response time, it tunes to a next channel. Otherwise, the requesting device may wait on the channel until the probe timer reaches a maximum probe response time and, thereafter, the requesting device processes all received probe responses. Optionally, the requesting device may then tune to scan the next channel. The probing procedure provides the requesting device with information on the wireless networks present in the area and, as a consequence, enables the requesting device to select a wireless network with which to establish a connection. The responding device receiving the probe request may respond with a probe response if an address field in the probe request frame is a broadcast address, an individual medium access control (MAC) address of the responding device, or a multicast address of the responding device. Another condition for causing the responding device to transmit the probe response is that the SSID in the probe request is a so-called wildcard SSID, the specific SSID of the responding device, or the specific SSID of the responding device is included in an SSID list element of the probe request. Yet another condition may be that the specific Mesh ID in the probe request is the specific Mesh ID of the responding device, or an address 3 field in the probe request is a wildcard BSSID, the BSSID of the responding device, or the MAC address of the peer device in a mesh BSS. Further conditions for responding to the probe request may also be set. In general, the probe request specifies the conditions defining the devices that should respond with the probe response. All devices that fulfil the conditions may attempt to transmit the probe response frame.

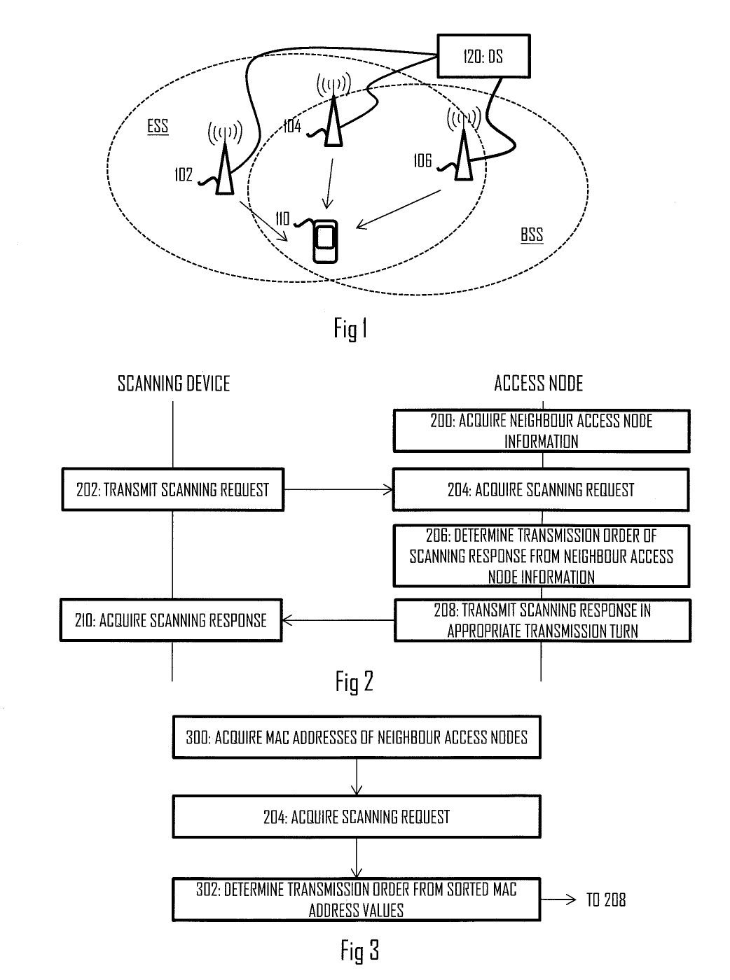

In general, the APs may transmit the scanning responses as responses to scanning requests received from scanning devices, e.g. scanning STAs. When the number of APs in the coverage area of the scanning device is high, the number of scanning responses may increase to such dimensions that the signalling overhead caused by the high number of scanning responses increases as does the channel contention the APs carry out in order to gain channel access to transmit their respective scanning responses. This increases the probability of collisions and increases scanning response total delays. Let us now consider an embodiment of the invention with reference to a signalling diagram of FIG. 2. The signalling diagram illustrates a process for reducing the signalling overhead caused by the probe responses by determining the transmission order of the scanning responses and reducing channel contention time upon determining the transmission order. The signalling diagram comprises steps carried out in an access node, e.g. any one of the APs 102 to 106, and steps carried out in a scanning device, e.g. the STA 110. Referring to FIG. 2 neighbour access node information comprising at least one of identification, geographical location, and characteristics of at least one neighbouring access node is acquired in the access node in block 200.

In block 202, the scanning device carries out an active scanning procedure and causes transmission of a scanning request message. In an embodiment, the scanning request message comprises context information, e.g. a location of the scanning device and/or service requirements of the scanning device. In other embodiments, the scanning request message of block 202 is a conventional scanning request message. In block 204, the scanning request message originated from the scanning device is acquired in the access node. Let us assume that the scanning request message specifies such conditions that obligate the access node to respond to the scanning request message with a scanning response message. Therefore, in block 206, a transmission order of a plurality of scanning responses that respond to the scanning request is determined at least partly on the basis of the neighbour access node information acquired in block 200. In some embodiments, block 206 comprises determining the transmission order also on the basis of the context information acquired from the scanning request message in block 202. On the basis of the transmission order, the access node is able to determine its transmission turn and, as a consequence, the access node is configured in block 208 to transmit a scanning response message during a transmission turn of the access node determined from the transmission order in block 206. The scanning response message of block 208 is the response to the scanning request of blocks 202 and 204. In block 210, the scanning device acquires the scanning response message.

In an embodiment, the scanning response message comprises an information element indicating the transmission turn of the scanning response message, and the scanning device may process the information element in block 210. The scanning device may use the information element to determine if one or more scanning responses have not been received, as will be described in greater detail below.

In an embodiment, the access nodes exchange their transmission turns over the DS 120 in order to ensure that the same transmission turn is not allocated to two access nodes. In another embodiment, a central server may carry out the procedure of FIG. 2 and distribute the transmission turns to the access nodes over the DS 120.

When the access node and other access nodes determine the transmission order of the scanning responses, the channel contention according to carrier sensing multiple access with collision avoidance (CSMA/CA), distributed coordination function (DCF), or enhanced distributed channel access (EDCA) may be avoided or at least reduced. For example, the duration of which an access node needs to sense the channel to be free before transmitting the scanning response message may be shorter than a sensing duration of another message for which no transmission order has been determined. In an example related to IEEE 802.11 networks, if no transmission order has been determined, the access node may need to sense the channel to be free for a duration of a DCF inter-frame space (DIFS) plus an additional random backoff time, and this duration may be reduced to a shorter duration such as point coordination function inter-frame space (PIFS) or short inter-frame space (SIFS) in the embodiment of FIG. 2. In some embodiments, the backoff time may even be omitted to reduce the channel contention. In an embodiment, the access node may determine whether or not its transmission turn is the first transmission turn in the transmission order determined in block 206. If the access node has the first transmission turn, it may apply a longer guard time and/or the backoff time before carrying out the transmission of the scanning response message than in a case where the transmission turn of the access node is not the first transmission turn. As a consequence, normal channel contention may be applied to the first transmission turn, but any subsequent transmission turn may be carried out without or at least with the reduced channel contention, e.g. with the reduced guard time and/or without the backoff time.

With respect to determining the actual transmission timing of its transmission turn, the access node may monitor the scanning response messages transmitted by the neighbouring access node as a response to the scanning request message. Assuming that the transmission turn of the access node is X, upon detecting a scanning response message comprising the transmission turn indicator indicating a transmission turn X−1, the access node may proceed to transmit its scanning response in the next transmission opportunity. If the access node does not detect the preceding scanning response message for some reason, it may carry out a normal channel contention in order to transmit the scanning response message, e.g. through the EDCA procedure. The channel contention may be triggered upon detecting no scanning response of the transmission turn X−1 within a determined time interval after the previous scanning response of the transmission turn X−2, for example. The determined time interval may be selected sufficiently short such that the access node may still transmit the scanning response during its transmission turn. For example, the determined time interval may be higher than the guard interval between consecutive scanning response messages, e.g. a PIFS or SIFS, but shorter than the guard interval plus the duration of the scanning response message. This ensures that the missed detection of a previous scanning response message is not propagated to the access nodes having a later transmission turn.

In another embodiment where a plurality of responding access nodes waiting for their transmission turn and monitoring for the scanning response messages detect no scanning response message in an arbitrary transmission preceding their transmission turns, the channel contention may be triggered in all the responding access nodes. From the point of view of a single access node, the access node may monitor for the scanning response messages of all transmission turns preceding its own transmission turn and, upon detecting no scanning response message in one these preceding transmission turns, the access node may trigger the channel contention in order to transmit the scanning response message even before its actual transmission turn. The channel contention may follow the EDCA procedures, and the access node may determine its backoff time from its transmission turn, for example. In an embodiment, the higher is the transmission turn value of the access node, the longer is the backoff time the access node has to wait for the channel to be free before gaining the transmission opportunity for the scanning response message. In another embodiment, the EDCA parameters of the group of contending responding access nodes are selected according to the number of contending responding access nodes, e.g. how much randomness is needed to randomly select non-colliding transmission times. The computation of the backoff time may be started upon making a decision that a scanning response message of a previous transmission turn has been missed or, alternatively, the computation of the backoff time may be started even when the access node is still scanning for the previous scanning response message, e.g. before the decision about missing the previous scanning response message has been missed. The latter option speeds up the channel contention by “emulating” the channel contention even before the channel contention is actually triggered. The access node may, however, prevent transmission of its own scanning response message before making the decision. Such embodiments where missed detection of a previous scanning response message triggers the channel contention in the responding access node also ensures that the missed detection of the previous scanning response message does not propagate to the access nodes having a later transmission turn.

In another embodiment, the access node may derive its transmission timing by monitoring for scanning response messages of other access nodes having a prior transmission turn. Upon detecting a scanning response message from a specific MAC address associated with the preceding transmission turn, the access node may determine that it has the next transmission turn and it may trigger the transmission of the scanning response message. In this embodiment, the access node associates the transmission turns with the MAC addresses of the neighbouring access nodes and monitors for the MAC addresses of the detected scanning response messages in order to determine its transmission turn.

In another embodiment, the access node may derive its transmission timing directly from the transmission turn when it has the knowledge of the lengths of all the preceding scanning responses. For example, the scanning response message may have a constant length, or the length information may be exchanged over the DS 120. The computation of the transmission timing may take into account the lengths of the previous scanning response messages and any possible guard intervals between them. For example, when the transmission turn is 3, the transmission timing may be computed as: DIFS+Average Backoff Time+Length of the 1^{st} Response including an acknowledgment to the 1^{st} Response+(P/S)IFS+Length of the 2^{nd} Response including an acknowledgment to the 2^{nd} Response+(P/S)IFS, assuming that all responses have been detected successfully. After the expiry of this time interval, the access node may determine that it is its transmission turn. However, if the exact transmission timing cannot be computed because of insufficient knowledge about the length or transmission status of the previous scanning responses, for example, the access node may carry out the procedure described above in the previous paragraph. This embodiment may be used within access nodes of the same ESS, e.g. an access node of an ESS may determine its transmission timing within the ESS in the above-described manner. A normal channel contention based on EDCA principles, for example, may be carried out between ESSs to gain the transmission opportunity for the scanning response messages within the ESS. In other words, the ESS winning the contention may continue to transmit all of its scanning response messages before the other ESS(s). In another embodiment, the ESS with the largest number of responding access nodes, which is available from the channel access coordination information element in Table 5 below, may transmit first without channel contention. Thereafter, the access nodes having subsequent transmission turns within the ESS may compute their actual transmission timings in the above-described manner. In a further embodiment, the first response message of the transmission order within the ESS or between service sets may be a long response message comprising parameters of at least some or even all of the access nodes having the following transmission turns, while the following scanning response messages comprise less information, e.g. a minimum set of information required for the scanning response message.

In any one of the above-described embodiments where the access node(s) is/are configured to detect the missed transmission of a scanning response message and to start the channel contention, the channel contention may first be carried out on a service set level. For example, a subset of access nodes of an ESS may start the channel contention upon detecting a missed scanning response message. Let us assume that one of the access nodes wins the channel contention and gains a transmission opportunity to transmit a scanning response message. Upon detecting that their ESS won the contention, the other access nodes of the ESS may be configured to carry out subsequent channel contentions with such EDCA parameters that provide the fastest channel access, e.g. the shortest backoff time. The use of the optimal EDCA parameters may be stopped upon detecting an intervening transmission by another device that is not party of the ESS. The intervening transmission may be detected after the ESS has won the contention but before all the access nodes of the ESS have had the chance to transmit the scanning response message. Let us assume that another ESS wins a contention between the scanning response transmissions of the ESS in question. Then, the option to use the optimal EDCA parameters may be passed to the other ESS, and upon detecting the won channel contention in an access node of the other ESS, the access node of the other ESS may implement the optimal EDCA parameters in a subsequent scanning response transmission. In summary, the missed detection of the previous scanning response in the transmission order may trigger the channel contention on the service set level, and winning the channel contention in a service set may trigger utilization of high priority or optimal EDCA parameters that provide fast channel access, thereby reducing the contention overhead.

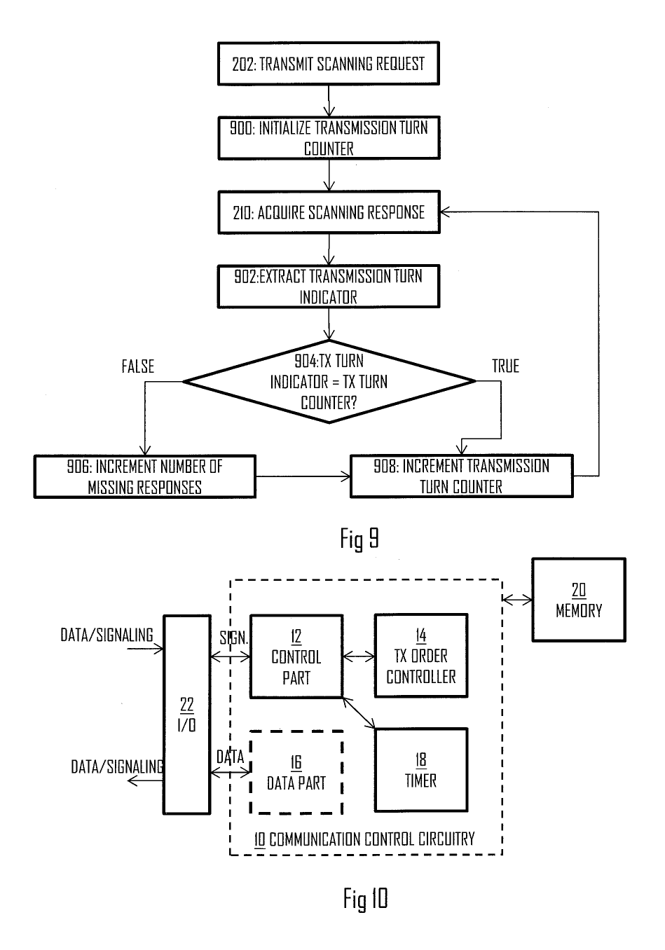

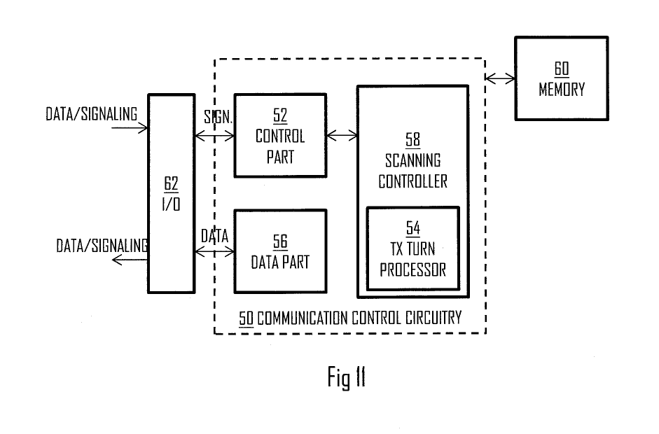

In an embodiment where the access nodes utilize a retry limit to retransmit the scanning response messages in case the access node does not receive an ACK frame. The retry limit may be set to 0 to disable the retransmissions in order to avoid collisions. The retransmissions may be disabled for broadcast-addressed frames but also for frames addressed to another address than the broadcast address. Instead, the transmission of a new scanning request may be initiated by the scanning device upon determining from the transmission turn indicator, for example, that it has missed at least one scanning response message (see embodiment of FIG. 9 below), thus enabling the retransmission functionality. In another embodiment where the retransmissions are not disabled, an access node waiting for its transmission turn may be configured to acquire the preceding probe response and associated acknowledgment or at least the acknowledgment of the preceding probe response before initiating its transmission turn.

In an embodiment, block 206 comprises a sub-routine where the access node is configured to filter the neighbouring nodes included in the determination of the transmission order on the basis of the conditions defining the responding devices included in the scanning request message. The access node may be configured to compare the parameters of the neighbouring access nodes with the conditions defined in the scanning request message and determine the neighbouring access nodes that are obliged to respond to the scanning request. Then, only those access nodes that are obliged to transmit the scanning response message may be taken into account when determining the transmission order in block 206.

In an embodiment, the scanning device includes in the scanning request a number of scanning responses it chooses to receive. Accordingly, the access node may include/remove itself to/from the transmission order based on the number of scanning responses indicated in the scanning request message. The access node may determine whether or not its own transmission turn value is higher than the number of scanning responses indicated in the scanning request message. If the transmission turn value of the access node is higher than the number of scanning responses indicated in the scanning request message, the access node may prevent the transmission of the scanning response message. Otherwise, it may carry out the transmission of the scanning response message in block 208, as described above.

In an embodiment, the scanning request message is the probe request message of an IEEE 802.11 network, and the scanning response message is a probe response message of the IEEE 802.11 network.

Let us now consider some embodiments for determining the transmission order in the access node with reference to FIG. 3 to 8. In some embodiments, the transmission order is determined by using a static parameter as a criterion, and such an embodiment may be called a policy-based approach. In other embodiments, the transmission order is determined by using semi-static or dynamic parameters as a criterion or criteria, and such an embodiment may be called a parameter-based or context-sensitive approach.

FIG. 3 illustrates an embodiment of a policy-based approach where identifiers of the access nodes are used to determine the transmission order. As mentioned above, the access nodes (e.g. APs 102 to 106) may be aware of any neighbouring access node through signalling over the DS 120 and/or over a radio interface. The access nodes may constantly transmit beacon frames, measurement pilot frames, and/or other management frames that comprise their identifiers and any relevant information on them. As a consequence, the access nodes gain information on the identifiers, capability information, and operational parameters of neighbouring access nodes. Such information may be exchanged a priori in block 200 through the DS 120 via inter-AP protocol (IAPP) in the background, or it may be stored in a network management database which is updated periodically and subsequently shared to all the APs having access to the database. Hence, an AP may gain knowledge of the all other APs in the same ESS through information exchange via the DS and of any other neighbouring AP through information exchange via the DS and/or the radio interface. Referring to FIG. 3, the access node acquires identifiers of the neighbouring access nodes as the neighbour access node information in block 300. In an embodiment, the identifier is a medium access control (MAC) address. Upon receiving the scanning request in block 204, the access node determines the transmission order from the identifiers in block 302. In an embodiment, the transmission order is determined from the identifiers by processing the identifier values of the access node and the neighbouring access nodes as such, e.g. by sorting the identifier values into an ascending or descending order, or by sorting them according to another predefined rule. When the neighbouring access nodes also carry out block 302, the access node may apply the same predefined rule as the neighbouring access nodes. Upon sorting the identifier values and acquiring a sorted list of identifiers, the access node may count its transmission turn from the location of its own identifier in the sorted list of identifiers. Upon determining its transmission turn, the access node may carry out the transmission of the scanning response during its transmission turn in block 208.

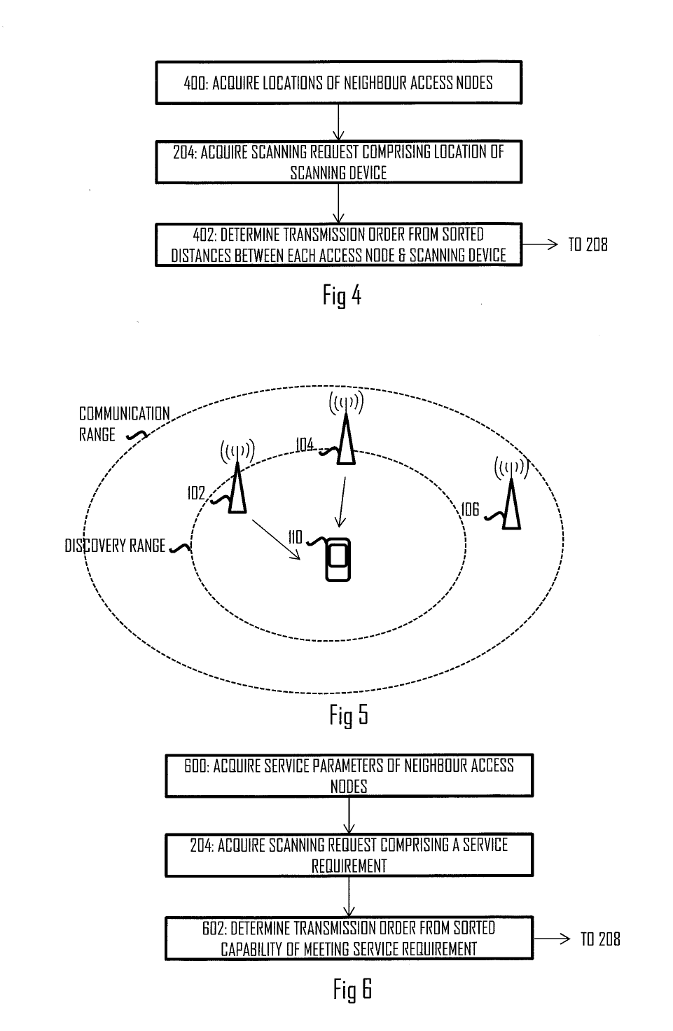

FIG. 4 illustrates a flow diagram of an embodiment using the context-sensitive approach by using positioning as a tool for determining the transmission order. Referring to FIG. 4, the access node may acquire the locations of the neighbouring access nodes in block 400. The format in which the location is described may be arbitrary, e.g. satellite system (GPS; GLONASS, Galileo) coordinates, any other geolocation coordinates, or any other positioning coordinates. In block 202 (FIG. 2), the scanning device transmits the scanning request. In this embodiment, the scanning request may comprise an information element indicating the location of the scanning device. The location information contained in the scanning response may be in the same format as the format of the location information in block 400. In block 204, the access node acquires the scanning request message and extracts the location of the scanning device from the scanning request message.

In block 402, the access node may compute the relative positions of the access node itself and the neighbouring access nodes to the scanning device and determine the transmission order by sorting the relative positions into an ordered list according to a predefined rule, e.g. in an ascending or descending order. In an embodiment using the ascending order, the access node having the shortest relative position to the scanning device gets the first transmission turn, the access node having the second shortest relative position to the scanning device gets the second transmission turn, and so on. The embodiment using the ascending order has the advantage that the scanning device acquires the scanning responses first from the access nodes that probably can provide the best radio link with the scanning device. The relative position may be computed according to state of the art techniques, e.g. according to Equation (1):

$${Δ}_{i} = \{ \begin{matrix}\sqrt{{( {x}_{2 , i} - {x}_{1} )}^{2} + {( {y}_{2 , i} - {y}_{1} )}^{2}} , 2 - D \\ \sqrt{{( {x}_{2 , i} - {x}_{1} )}^{2} + {( {y}_{2 , i} - {y}_{1} )}^{2} + {( {z}_{2 , i} - {z}_{1} )}^{2}} , 3 - D .\end{matrix} \qquad ( 1 )$$

Depending on whether the format of the location information utilizes two-dimensional (2-D) or three-dimensional (3-D) coordinates, one of the options for computing the relative position Δᵢ of Equation (1) may be selected. Instead of using the Cartesian coordinates of the two locations, e.g. the location of the scanning device defined by coordinates [x₁, y₁, z₁] and the location of the i-th access node defined by coordinates [x_{2,i}, y_{2,i}, z_{2,i}], as in Equation (1), the computation may be carried out by using any other coordinates, e.g. sphere coordinates or Geodetic coordinates according to World Geodetic System-84 (WGS-84). Note that instead of the relative position, Equation (1) may be understood as a computation of relative distances between the scanning device and the access nodes, and the relative distance may be used in determining the transmission order.

In an embodiment where the scanning device limits the number of scanning responses, the limitation may be based on the actual number value defining the number of scanning responses or the limitation may be based on the geolocation, as described now with reference to FIG. 5. The scanning device may include in block 202 in the scanning request message an information element that specifies a discovery range. The discovery range may define a perimeter around the scanning device, and only the access nodes that are located within the perimeter are obliged to respond, provided that those access nodes also comply with any other conditions set out in the scanning request message. FIG. 5 illustrates an embodiment where the access nodes 102 and 104 are located within the discovery range, while the access node 106 is outside the discovery range. Therefore, even though the access node 106 is able to detect the scanning request and meets the other conditions set out in the scanning request, it will not respond to the scanning request message, and it will be excluded when determining the transmission order for the scanning response messages in block 402, for example.

In an embodiment, the discovery range is smaller than the communication range of the scanning device, as shown in FIG. 5. In an embodiment, the scanning device is configured to compute a discovery zone defined by the discovery range is defined as:

$${r}_{discovery} = \frac{{R}_{tx}}{2} {r}^{*} \qquad ( 2 )$$

where r_{discovery} is the discovery range in the form of a radius, for example, Rₜₓ is the transmission range of the scanning device which may be preset and stored beforehand in the scanning device, and r* is a scaling factor having a value between 0 and 1, for example. In this embodiment, the discovery range is at most half of the communication range of the scanning device. Reducing the discovery range provides the advantage that it improves the probability that all access points within the discovery range are able to detect each other and, thus, effects of a hidden access node problem are eliminated or at least reduced.

Another embodiment utilizes characteristics of the access nodes to determine the transmission order for the scanning response messages. The characteristics may comprise operational parameters or service parameters of the access nodes. Referring to a flow diagram of FIG. 6, such service parameters of the access node and the neighbour access nodes are acquired in block 600. Such parameters may comprise any metric related to a current load or capacity of the access nodes, e.g. data rate, throughput, buffer occupancy, packet delay, and packet loss. In an embodiment, a plurality of characteristics may be combined to provide a service quality metric as the service parameter. Then, the scanning device transmits in block 202 (FIG. 2) the scanning request message, and it may include in the scanning request message in information element specifying service requirements of the scanning device. The service requirements may be provided in the form of an access class or quality-of-service (QoS) class, but other service requirements are naturally possible. The service requirements specified by the scanning device may be compatible with the service parameters defined in block 600, or there may be a correspondence between them such that the access node is able to map the service requirements to the service parameters. In block 204, the scanning request message is acquired in the access node, and the service requirements are extracted from the scanning request message. In block 602, the service parameters acquired in block 600 are sorted, and the transmission order is determined from the sorted list. The sorting may comprise a first step where those access nodes that are not able to meet the service requirements are excluded, and a second step where the remaining access nodes that are able to meet the service requirements are ordered, for example, on the basis of how well they meet the service requirements. In an embodiment, an access node capable of providing the scanning device with the highest service quality gets the first transmission turn and so on. The highest service quality may be defined as the highest available capacity which may be inferred from the lowest buffer occupancy, the highest throughput or data rate, or the lowest packet loss or packet delay. As a consequence, the access node acquires its transmission turn and may carry out the transmission of the scanning response during its transmission turn in block 208.

In the embodiments described above in connection with FIGS. 4 to 6 where the access node closest to the scanning device or having the capability that best meet with the service requirements gets the first transmission turn, the transmission order itself indicates to the scanning device those access nodes that are the most promising candidates for the association. Accordingly, the scanning device may prefer the access nodes from which it receives the scanning response first. In an embodiment, the scanning device may even be configured to cancel the scanning process upon selecting an access node with which to associate. To this end, the scanning device may be configured to transmit a scanning termination message, e.g. a Probe End frame instead of an ACK frame, thereby cancelling any subsequent scanning response transmission or transmissions of the transmission order. An access node that has not yet had its transmission turn and detecting the scanning termination message may cancel its transmission turn and, as a consequence, prevent the transmission of the scanning response message.

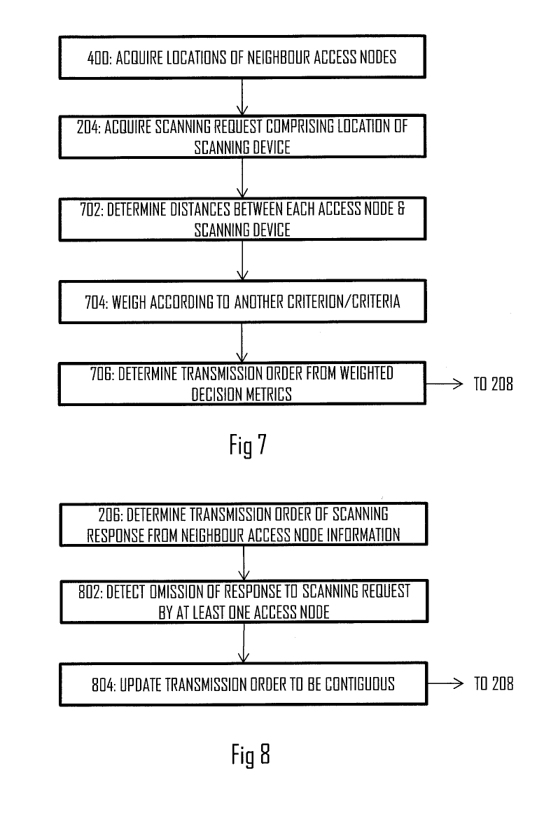

In an embodiment, the transmission order is determined from a plurality of input parameters that are combined in a determined manner. FIG. 7 illustrates a flow diagram of an embodiment where the relative positions between the access nodes and the scanning device are the first input parameter, and this first input parameter is then weighted with a second input parameter which may comprise, for example, the above-described service parameter(s) and/or any other conditions set out in the scanning request message. Referring to FIG. 7, the access node acquires the locations of the neighbour access nodes in block 400 and the scanning request message in block 204. Depending on the embodiment, the scanning request may comprise the location of the scanning device and, optionally, the service requirements. In block 702, the access node may determine the relative positions Δ between each access node and the scanning device in the above-described manner. As a result, the access node acquires a set of distance values {Δ₁, Δ₂, . . . , Δₖ}. The distance values may then be used as such in the sorting, or the access point may normalize the relative position values according to Equation (3):

$${Δ}_{i}^{*} = \frac{UB - {Δ}_{i}}{UB - LB} \qquad ( 3 )$$

where UB is a maximum value in the set of relative position values {Δ₁, Δ₂, . . . , Δₖ}, and LB is a minimum value in the set of relative position values {Δ₁, Δ₂, . . . , Δ_{K}}. As a result of computing Equation (3), an access node closest to the scanning device gets a value 1, while an access node having the greatest distance to the scanning device gets a value 0.

In block 704, the access node then weighs the acquired normalized relative position values according to another criterion or criteria, thus acquiring decision metrics for the sorting operation. The access node may multiply each normalized relative position value with a priority factor which may be derived according to the matching between the service requirements set out in the scanning request message and the characteristics of the access nodes. Alternatively, or additionally, the priority factor may be derived according to matching between the conditions for the obligation to respond set out in the scanning request and the characteristics of the access nodes. The priority factor may be proportional to a percentage how well each access node is able to match with the service requirements and/or the conditions. In an embodiment, the value of the priority factor may be between 0 and 1. Then, the transmission order may be determined from these weighted decision metrics by sorting them according to a determined criterion. The sorting may again be arranged such that the access nodes being closest to the scanning device and being able to best meet the service requirements and/or conditions gain the first transmission turn(s), while the access nodes far away from the scanning device and not being able to well meet the service requirements and/or conditions gain the last transmission turns or even no transmission turn at all. For example, if the closest access node gains the lowest normalized relative position according to Equation (3), the weighing may assign a lower priority factor to those access nodes that best meet the service requirements and/or conditions, and the decision metrics may be sorted into an ascending order such that an access node with the lowest decision metric value gains the first transmission turn.

The embodiments described above in connection with FIG. 7 have an advantage in that improve the probability that the access nodes having the best capability of serving the scanning device gain the opportunity to transmit the scanning response message before the access nodes not capable of well serving the scanning device.

During operation of the wireless network and the access nodes, there may exist situations where an access node is not able to transmit the scanning response message for some reason or another. In order to avoid unused transmission turns, the access node may be configured to update the transmission order, when necessary. FIG. 8 illustrates a flow diagram of an embodiment for updating an initial transmission order determined in block 206, 302, 402, 602, or 706, for example. In the embodiment of FIG. 8, block 206 is used as an example. In block 802, the access node detects that at least one of the access nodes having a transmission turn in the transmission order skips its transmission turn. The at least one skipping access node may be at least one neighbouring access node. The reason for skipping the transmission of the scanning response message may be that the access node determines that its traffic load is so high that it does not want to serve further terminal devices, or it may detect that the matching between the service requirements and its service characteristics is not sufficient. Upon determining to skip the transmission turn, the skipping access node may be configured to transmit an appropriate signal through the DS 120 and, as a consequence, the detection in block 802 may be based on reception of such a signal through the DS 120. In an embodiment, the signal comprises an information element that indicates that the transmission turn of the skipping access node is zero (0). Upon receiving the signal indicating that the transmission turn of a neighbouring access node is 0, the access node knows that the access node with response order 0 will be skipped in the transmission order, and it may update the transmission order in block 804 by removing the skipping access node's transmission turn and decrementing the transmission turn of all access nodes having a transmission turn after the transmission turn of the skipping access node. Thus, the transmission order remains contiguous and without unused transmission turns. Then, the access node may transmit its scanning response during its transmission turn determined from the updated transmission order.

As mentioned above, the scanning response messages transmitted by the responding access nodes may comprise the information element indicating the transmission turn of each scanning response message. This enables the scanning device to monitor the scanning response messages and to determine whether or not it has received all the scanning responses. Upon detecting that consecutively detected scanning response messages do not have consecutive transmission turn indicators, the scanning device may determine that at least one scanning response has been missed. FIG. 9 illustrates an embodiment of such a procedure for detecting missed scanning response messages in the scanning device. Referring to FIG. 9, the scanning device transmits the scanning request message in block 202. The scanning request message may be any one of the above-mentioned scanning requests, e.g. it may or may not comprise the context information, e.g. the location of the scanning device and/or the service requirements. In block 900, the scanning device initializes a transmission turn counter. Block 900 may also comprise initialization of a missed scanning response counter. In block 210, the scanning device acquires the first scanning response message that responds to the scanning request message of block 202. In block 902, the scanning device extracts from the acquired scanning response message the transmission turn indicator. In block 904, the scanning device compares the transmission turn indicator value with the transmission turn counter. If the values match, it is determined that no scanning response messages have been missed, and the process proceeds to block 908 in which the transmission turn counter is incremented by one and the scanning device returns to monitor for a next scanning response message. Upon detecting the next scanning response message, the process proceeds in block 210.

However, if the transmission turn indicator value and the transmission turn counter in block 904 are different, this means that there has been at least one scanning response message preceding the currently processed scanning response message that has not been detected by the scanning device. As a consequence, the process proceeds from block 904 to block 906 in which the missed scanning response counter is incremented. The increment is determined on the basis of the difference between the transmission turn indicator value and the transmission turn counter. For example, if the transmission turn indicator value minus the transmission turn counter equals to two, two scanning responses have been missed, and the missed scanning response counter is incremented by two. Then, the process proceeds to block 908 in which the transmission turn counter is incremented by the same amount as the value of the number of missed scanning responses in block 906. In this manner, the transmission turn counter is updated to an appropriate value by taking into account the number of missed scanning responses.

Upon detecting that the scanning device has missed a determined number of scanning response messages, it may transmit a new scanning request message in order to receive the scanning responses from those access nodes that were not detected during the first active scanning. The scanning device may also include a filtering list in the new scanning request so that scanning responses from known wireless networks (as a result from the first scanning request message) need not be retransmitted.

Let us now consider some embodiments of information elements contained in the above-described scanning request message and scanning response messages. The access nodes may employ the ordered transmission of the scanning responses by default, or the scanning request message may comprise an information element that triggers the ordered transmission of the scanning responses. In the IEEE 802.11 networks, such an information element may be dot11_EnhancedProbing, and its value may be set to “true” to trigger the ordered transmission.

As mentioned above, the scanning device may add to the scanning request message an information element comprising the context information, e.g. the location and/or the service requirements of the scanning device. With respect to the location, the scanning request message may comprise an information element of Tables 1 and 2 below. In this embodiment, the scanning request message is assumed to be a Probe Request message of IEEE 802.11, and it may be modified to include the following context information element:

TABLE 1

| Order | Information | Notes |
|---|---|---|
| 14 | Geo-location of | Present when dot11_EnhancedProbing is |
| | scanning device | true and location type is geolocation |

The format of the context information element may be as shown in Table 2:

TABLE 2

| | | | | | | Ref- | | | |
|---|---|---|---|---|---|---|---|---|---|
| | | | | | | erence | | | Maximum |
| ID | Length | X | Y | Z | Radius | Offset | DZR | Other | Responses |
| 1 | 1 | 4 | 4 | 4 | 4 | 4 | 4 | 4 | 1 |

The number value below each field defines the length of the field in octets. The ID field identifies the information element. The Length defines the length of the information element and it may be set to either to 8 or 29 octets depending on the number of fields included in the information element. An X-coordinate field contains a 4 octet single precision floating point value defining the location of the scanning device in an X domain. A Y-coordinate field contains a 4 octet single precision floating point value defining the location of the scanning device in a Y domain. Y and X domains may form the Cartesian coordinates which is a two-dimensional location value of the scanning device, Z-coordinate, Radius, Reference Offset, Discovery Zone Radius (DZR), Other Requirement, and Maximum Responses fields may be optional. Each of the Z-coordinate field, the Radius field, and the Reference Offset field may contain a 4 octet single precision floating point value. A Z-coordinate field may define the location of the scanning device in a Z domain and it may be used with the Cartesian coordinates to form a three-dimensional location value of the scanning device. A Radius field may be used with the Cartesian coordinates to form the circle location value of the scanning device. Accordingly, the location of the scanning device may be provided as a point location by using the X, Y and optionally Z coordinates, or as an area location by providing also the Radius field. The additional Z-coordinate and Radius fields together may be used to form the sphere location value of the scanning device. An additional Reference Offset field may be used to form a relative location value of the scanning device with respect to the baseline location defined by the X, Y, (and Z) coordinates. This may be useful in an indoor environment, wherein a baseline location value includes the X-Coordinate field and the Y-Coordinate field and may also include the Z-Coordinate field. The baseline location value may specify a building containing the relative location of the scanning device, and the Reference Offset could specify a point within the building, e.g. a centre of the building from which the offset is measured. A Discovery Zone Radius field may contain a 4 octet single precision floating point value which, together with the X and Y coordinates defines the above-mentioned discovery range. Note that a constraint may be imposed to limit the value of the Radius field to be less than the value of the Discovery Zone Radius field in order to eliminate or at least reduce the hidden access node problem. In addition, the knowledge of both the Radius field and the Discovery Zone Radius field may enable fast determination of transmission order. Let us assume an example with three access nodes. One access node is located within both the Radius and Discovery Zone Radius, one access node is located between the Radius and Discovery Zone Radius, and one access node is located beyond the Discovery Zone Radius, for example. In this case, the transmission order may be determined by using both the Radius and Discovery Zone Radius as ranking thresholds, without computing and ranking the outcome of Equation (1). An access node computing the transmission order may assign a prior transmission turn to access node(s) that is/are located within the area defined by the location of the scanning device and the Radius zone and a subsequent transmission turn to access node(s) that is/are located outside the area defined by the location of the scanning device and the Radius zone and inside the Discovery Zone Radius. Access node(s) outside the Discovery Zone Radius may be excluded from the transmission order. The Other Requirement (Other) field may be used as a 4 octet single precision floating point value containing the service requirements of the scanning device such as its required packet delay, packet loss rate, buffer occupancy, or any statistic that may be mapped to the characteristics of the access nodes, e.g. the load of the access nodes. The Maximum Responses field may contain a single octet unsigned integer which provides a criterion to limit the number of scanning responses.

In an embodiment where only the service requirements are used as the context information, the scanning request message may comprise an information element comprising the Other Requirement field without the location and discovery range fields of Table 2. The Maximum Responses field may be included or omitted. In an embodiment using the policy-based approach, e.g. the identifiers of the access nodes, to determine the transmission order, even the Other Requirement field may be omitted. The Maximum Responses field may be included or omitted.

In another embodiment, the location of the scanning device is defined as a civic location instead of a geolocation, and the information element of Tables 1 and 2 may be modified accordingly. For example, Table 2 may be modified into the following form as shown in Table 3.

TABLE 3

| | | Civic | | | | | | | |
|---|---|---|---|---|---|---|---|---|---|
| | | Location | Optional | Civic | | Reference | | | Maximum |
| ID | Length | Type | Subelements | Location | Radius | Offset | DZR | Other | Responses |
| 1 | 1 | 1 | Variable | Variable | 4 | 4 | 4 | 4 | 1 |

Civic Location Type field indicates the format of location information in the Civic Location field. Optional Subelements field may comprise zero or more subelements with information that specifies a MAC address of the scanning device and a target MAC address of the scanning request message, the format in which the location is provided, e.g. the shape of the location, and so on as known in connection with IEEE 802.11v specifications. The civic location field may comprise the actual location information in the appropriate format.

In other embodiments, another format of the location is used, and in each embodiment the format of the information element of Table 1 may be selected to comply with the location format. The information element may still comprise any one or more of the fields of Table 2, e.g. the DZR field and the Maximum Responses field.

The access node may be configured to insert into the scanning response message an information element indicating the transmission turn. The transmission turn information element may carry the transmission turn of the transmitted scanning response frame so that the scanning device knows exactly which ordered probe response has not been successfully received, if any. Additionally, or alternatively, the access node may be configured to insert into the scanning response message a channel access coordination information element comprising the neighbour access node information of block 200. The channel access coordination information element may contain the geo-location of the responding access node and, optionally, fields that may be used for coordinating the transmission order within the discovery zone. Note that the channel access coordination information element may be included in another scanning message broadcasted or advertised over the radio interface in order to advertise the presence of the access node or the ESS. Such a message may be a beacon frame or a measurement pilot frame, for example. An example of the information elements added to a conventional scanning response message, e.g. the Probe Response message of IEEE 802.11, is shown in Table 4:

TABLE 4

| Order | Information | Notes |
|---|---|---|
| 35 | Channel access | Present when |
| | coordination | dot11_EnhancedProbing is “true” |
| 36 | Transmission turn | Present when |
| | | dot11_EnhancedProbing is “true” |

Table 5 below shows an example of the format of the channel access coordination information element of Table 4.

TABLE 5

| | | | | | | Number | | |
|---|---|---|---|---|---|---|---|---|
| | | | | | | of Re- | Re- | |
| | | | | Relative | | sponding | sponse | |
| ID | Length | X | Y | Position | HESSID | APs | Length | Other |
| 1 | 1 | 4 | 4 | 4 | 6 | 1 | 1 | 4 |

The length field may be set to either 8 or 23 depending on the fields included in the information elements. The X-coordinate field contains a 4 octet single precision floating point value defining the location of the access node in the X domain. The Y-coordinate field contains a 4 octet single precision floating point value defining the location of the access node in the Y domain. The Relative Position, homogeneous ESS ID (HESSID), Number of Responding APs, Response Length, and Other fields may be optional. The Relative Position field may contain a 4 octet single precision floating point value which represents the displacement between the access node and the scanning device along an imaginary straight line which is the shortest distance between these two positions. It may be computed according to Equation (1) or (3), for example, and other access nodes may use the relative position instead of computing Equation (1) or (3) for each neighboring access node when determining the transmission order based on the relative position, as described above. The HESSID field may be a 6 octet MAC address that identifies a homogeneous ESS, and it may be identical to one of the BSS IDs in the homogeneous ESS. It may be a globally unique identifier that may be used in conjunction with the SSID to provide network identification. The Number of Responding APs field is a single octet unsigned integer which specifies the number of responding APs of a specific ESS that are within the discovery zone and that meet the conditions set out in the scanning request message. The Other field may be a 4 octet single precision floating point value which may contain other context information of the access node, e.g. its characteristics such as the packet delay, packet loss rate, buffer occupancy, or any statistic that may characterize the load of the access node and that may be compared with the service requirements of the scanning request message. With respect to the above-described embodiment where the access node computes the transmission timing of its transmission turn from the transmission order beforehand, the channel access coordination information element may further comprise a Response Length field which specifies the length of the scanning response messages the access node uses.

The Channel Access Coordination information element may be used for information exchange over the radio interface when an access node does not have prior location information of neighbouring access nodes that belong to its own service set or another service set.

An example of the format of the transmission turn information element is shown below in Table 6.

TABLE 6

| Element ID | Length | Transmission Turn |
|---|---|---|
| 1 | 1 | 1 |

The length field may be set to 1. The Transmission Turn field may contain a single octet unsigned integer value comprising the transmission turn indicator which represents the transmission turn of the scanning response in the transmission order.

The Channel Access Coordination and Transmission Turn information elements may be included in the probe response frame when dot11_EnhancedProbing is true. Additionally, the Channel Access Coordination information element may be included in a beacon, advertisement, or any Action frame.

FIG. 10 illustrates an embodiment of an apparatus comprising means for carrying out the above-mentioned functionalities of the access node. The apparatus may be an apparatus of an IEEE 802.11 network or another wireless network, e.g. an access point 102, 104, 106 or the central server controlling the operation of the access points 102, 104, 106. The apparatus may be a personal computer (PC), a server computer, a laptop, a tablet computer, a cellular phone, a palm computer, a fixed base station, or any other device provided with radio communication capability or controlling the operation of the access points. In another embodiment, the apparatus is comprised in such a device, e.g. the apparatus may comprise a physical circuitry, e.g. a chip, a processor, a micro controller, or a combination of such circuitries.

The apparatus may comprise a communication controller circuitry 10 configured to control the communications. The communication controller circuitry 10 may comprise a control part 12 handling control signalling communication with respect to transmission, reception, and extraction of control or management messages including the scanning messages. The control part 12 may handle the reception of the scanning request messages and transmission of the scanning response messages and other action frames. The control part 12 may further acquire any knowledge of the neighbouring access nodes through radio interface and/or through the DS 120. The communication controller circuitry 10 may further comprise a data part 16 that handles transmission and reception of payload data during transmission opportunities of the access node (transmission) or transmission opportunities of other devices (reception). If the apparatus is the central server, the data part 16 may be omitted unless payload data is routed through the server, and the control part may handle exchange of control messages between the server and the access nodes.

The communication controller circuitry 10 may further comprise a transmission order controller circuitry 14 configured to determine the transmission order according to any one of the above-described embodiments. The transmission order controller circuitry 14 may further determine the transmission turn of the access node comprising the apparatus and control the control part 12 to transmit the scanning responses during the determined transmission turns.

The communication controller circuitry 10 may further comprise a timer 18 used to determine the actual transmission timing of the scanning response messages. The timer 18 may be used to count any guard interval before the transmission of the scanning response messages and any interval used to determine that a scanning response message associated with a preceding transmission turn has not been detected.

The circuitries 12 to 18 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 12 to 18 or all of them.

The apparatus may further comprise a memory 20 storing computer programs (software) configuring the apparatus to perform the above-described functionalities for determining the transmission order and transmission turn of the scanning response messages. The memory 20 may also store communication parameters and other information needed for the wireless communications, e.g. the identifiers and any relevant operational parameters or characteristics of the neighbouring access point(s) that have been detected. The apparatus may further comprise input/output (I/O) components 22 providing the apparatus with communication capabilities. In an embodiment, the I/O components 22 comprise radio interface components 22 providing the apparatus with radio communication capability with terminal devices, access points, and/or the server. The radio interface components may comprise standard well-known components such as amplifier, filter, frequency-converter, (de)modulator, and encoder/decoder circuitries and one or more antennas. In another embodiment, the I/O components 22 provide the apparatus with wired communication capability to communicate with access points and the server.

In an embodiment, the apparatus carrying out embodiments of the invention in the apparatus comprises at least one processor and at least one memory including a computer program code, wherein the at least one memory and the computer program code are configured, with the at least one processor, to cause the apparatus to carry out the above-described functionality for determining the transmission order, as described above in connection with FIGS. 2 to 8. Accordingly, the at least one processor, the memory, and the computer program code form processing means for carrying out embodiments of the present invention in the apparatus.

FIG. 11 illustrates an embodiment of an apparatus comprising means for carrying out the above-mentioned functionalities of the above-described requesting device or the scanning device configured to carry out an active scanning process involving the scanning request messages and the scanning response messages. The apparatus may be a wireless apparatus of an IEEE 802.11 network or another wireless network, e.g. a STA. The apparatus may be a computer (PC), a laptop, a tablet computer, a cellular phone, a palm computer, or any other apparatus provided with radio communication capability. In another embodiment, the apparatus is comprised in such a wireless apparatus, e.g. the apparatus may comprise a physical circuitry, e.g. a chip, a processor, a micro controller, or a combination of such circuitries in the wireless apparatus.

The apparatus may comprise a communication controller circuitry 50 configured to control the communications in the wireless apparatus. The communication controller circuitry 50 may comprise a control part 52 handling control signalling communication with respect to transmission, reception, and extraction of control or management frames including the scanning request messages and the scanning response messages, as described above. The communication controller circuitry 50 may further comprise a data part 56 that handles transmission and reception of payload data during transmission opportunities of the wireless apparatus (transmission) or transmission opportunities of other wireless apparatuses (reception). The communication controller circuitry 50 may further comprise an active scanning controller circuitry 58. The active scanning controller circuitry 58 may be configured to handle the active scanning procedure comprising the transmission of the scanning request message comprising context information and the reception of the scanning response messages. The active scanning controller circuitry 58 may be configured to determine the context information included in the scanning request message. The active scanning controller circuitry 58 may comprise a transmission turn processor 54 configured to monitor for the transmission turn indicators comprised in the acquired scanning response messages and detect any response messages that has been missed according to the embodiment of FIG. 9, for example.

The circuitries 52 to 58 of the communication controller circuitry 50 may be carried out by the one or more physical circuitries or processors. In practice, the different circuitries may be realized by different computer program modules. Depending on the specifications and the design of the apparatus, the apparatus may comprise some of the circuitries 52 to 58 or all of them.

The apparatus may further comprise a memory 60 to store computer programs (software) configuring the apparatus to perform the above-described functionalities of the scanning device. The memory 60 may also store communication parameters and other information needed for the wireless communications, e.g. contents and format of context information to be added to the scanning response messages. The apparatus may further comprise radio interface components 62 providing the apparatus with radio communication capabilities within a service sets or between service sets. The radio interface components 62 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the wireless apparatus comprises at least one processor and at least one memory including a computer program code, wherein the at least one memory and the computer program code are configured, with the at least one processor, to cause the apparatus to carry out the functionality of the scanning device described above in connection with any one of the embodiments of FIGS. 2 to 9. Accordingly, the at least one processor, the memory, and the computer program code form processing means for carrying out embodiments of the present invention in the apparatus functioning in the scanning device.

As used in this application, the term ‘circuitry’ refers to all of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit or applications processor integrated circuit (ASIC) for the apparatus according to an embodiment of the invention.

The processes or methods described in FIGS. 2 to 9 may also be carried out in the form of a computer process defined by a computer program. The computer program may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

The present invention is applicable to wireless communication systems defined above but also to other suitable communication systems. The protocols used, the specifications of communication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1. A method comprising:
acquiring, in an access node of a wireless network, neighbour access node information comprising at least one of identification, geographical location, and characteristics of at least one neighbouring access node;
acquiring a scanning request message originated from a requesting device;
determining, at least partly on the basis of the neighbour access node information, a transmission order of a plurality of scanning responses that respond to the scanning request; and
causing the access node to transmit a scanning response during a transmission turn of the access node determined from the transmission order.

2. The method of claim 1, wherein the identification comprises a medium access control address of the at least one neighbouring access node, and wherein the transmission order is determined from the medium access control address values of the access node and the at least one neighbouring access node by sorting the medium access control address values into an ascending or descending order.

3. The method of claim 1, wherein the scanning request comprises context information, the method further comprising determining the transmission order of the plurality of the scanning responses further on the basis of the context information of the scanning request.

4. The method of claim 3, wherein the context information comprises at least one of a location of the requesting device, a distance parameter defining a response zone in which the scanning response is requested, a service requirement of the requesting device, and a maximum number of responses requested by the requesting device.

5. The method of claim 1, wherein if the transmission turn of the access node is the first transmission turn in the transmission order, causing the access node to transmit the scanning response message on a channel upon detecting that the channel has been free for a first duration, and if the transmission turn of the access node is later than the first transmission turn in the transmission order, causing the access node to transmit the scanning response message during its transmission turn on the channel upon detecting that the channel has been free for a second duration which is shorter than the first duration.

6. The method of claim 1, further comprising causing the access node to transmit a scanning response amongst the plurality of scanning responses to the requesting device in a transmission turn of the access node determined from the transmission order, wherein the scanning response comprises a transmission turn indicator indicating the transmission turn of the access node within the transmission order of the plurality of scanning responses.

7. The method of claim 1, wherein the scanning request comprises the location of the requesting device, the method further comprising:
acquiring locations of neighbour access nodes; and
determining the transmission order from the locations of the access node and the neighbour access nodes.

8-11. (canceled)

12. The method of claim 1, wherein the scanning request comprises a probe request, the scanning response comprises a probe response, and the neighbour access node comprises a neighbour access point of an IEEE 802.11 network.

13. A method comprising:
causing a scanning device to transmit a scanning request comprising context information to a plurality of access nodes;
acquiring in the scanning device a scanning response from an access node, wherein the scanning response comprises an information element indicating a transmission turn of the scanning response in a transmission order of a plurality of scanning responses responding to the scanning request.

14. The method of claim 13, wherein the context information comprises at least one of a location of the scanning device, a distance parameter defining a response zone in which the scanning response is requested, a service requirement of the scanning device, and a maximum number of responses requested by the scanning device.

15. (canceled)

16. The method of claim 13, further comprising:
determining from the transmission turn acquired from the scanning response that at least one other scanning response having a prior transmission turn has not been acquired; and
in response to determining that the at least one other scanning response has not been acquired, causing the scanning device to transmit another scanning request to receive the at least one other scanning response that was determined as not received.

17. (canceled)

18. An apparatus comprising:
at least one processor; and
at least one memory comprising a computer program code, wherein the at least one memory and the computer program code are configured, with the at least one processor, to cause the apparatus to:
acquire neighbour access node information comprising at least one of identification, geographical location, and characteristics of at least one neighbouring access node;
acquire a scanning request message originated from a requesting device;
determine, at least partly on the basis of the neighbour access node information, a transmission order of a plurality of scanning responses that respond to the scanning request; and
cause an access node to transmit a scanning response during a transmission turn of the access node determined from the transmission order.

19. The apparatus of claim 18, wherein the identification comprises a medium access control address of the at least one neighbouring access node, and wherein the at least one memory and the computer program code are configured, with the at least one processor, to cause the apparatus to determine the transmission order from the medium access control address values of the access node and the at least one neighbouring access node by sorting the medium access control address values into an ascending or descending order.

20. The apparatus of claim 18, wherein the scanning request comprises context information, and wherein the at least one memory and the computer program code are configured, with the at least one processor, to cause the apparatus to determine the transmission order of the plurality of the scanning responses further on the basis of the context information of the scanning request.

21. The apparatus of claim 20, wherein the context information comprises at least one of a location of the requesting device, a distance parameter defining a response zone in which the scanning response is requested, a service requirement of the requesting device, and a maximum number of responses requested by the requesting device.

22. The apparatus of claim 18, wherein if the transmission turn of the access node is the first transmission turn in the transmission order, the at least one memory and the computer program code are configured, with the at least one processor, to cause the apparatus to cause the access node to transmit the scanning response message on a channel upon detecting that the channel has been free for a first duration, and if the transmission turn of the access node is later than the first transmission turn in the transmission order, the at least one memory and the computer program code are configured, with the at least one processor, to cause the apparatus to cause the access node to transmit the scanning response message during its transmission turn on the channel upon detecting that the channel has been free for a second duration which is shorter than the first duration.

23. The apparatus of claim 18, wherein the at least one memory and the computer program code are configured, with the at least one processor, to cause the apparatus to cause the access node to transmit a scanning response amongst the plurality of scanning responses to the requesting device in a transmission turn of the access node determined from the transmission order, wherein the scanning response comprises a transmission turn indicator indicating the transmission turn of the access node within the transmission order of the plurality of scanning responses.

24. The apparatus of claim 18, wherein the scanning request comprises the location of the requesting device, and wherein the at least one memory and the computer program code are configured, with the at least one processor, to cause the apparatus to:
acquire locations of neighbour access nodes; and
determine the transmission order from the locations of the access node and the neighbour access nodes.

25-28. (canceled)

29. The apparatus of claim 18, wherein the scanning request comprises a probe request, the scanning response comprises a probe response, and the neighbour access node comprises a neighbour access point of an IEEE 802.11 network.

30. An apparatus comprising:
at least one processor; and
at least one memory comprising a computer program code, wherein the at least one memory and the computer program code are configured, with the at least one processor, to cause the apparatus to:
cause a scanning device to transmit a scanning request comprising context information to a plurality of access nodes;
acquire a scanning response from an access node, wherein the scanning response comprises an information element indicating a transmission turn of the scanning response in a transmission order of a plurality of scanning responses responding to the scanning request.

31. The apparatus of claim 30, wherein the context information comprises at least one of a location of the scanning device, a distance parameter defining a response zone in which the scanning response is requested, a service requirement of the scanning device, and a maximum number of responses requested by the scanning device.

32. (canceled)

33. The apparatus of claim 30, wherein the at least one memory and the computer program code are configured, with the at least one processor, to cause the apparatus to:
determine from the transmission turn acquired from the scanning response that at least one other scanning response having a prior transmission turn has not been acquired; and
in response to determining that the at least one other scanning response has not been acquired, cause the scanning device to transmit another scanning request to receive the at least one other scanning response that was determined as not received.

34-37. (canceled)
